(19) United States
(12) Patent Application Publication
(10) Pub. No.: US 2009/0213465 A1
(43) Pub. Date: Aug. 27, 2009

(54) LIGHT DIFFUSION FILM

(75) Inventors: Hideyuki Yonezawa, Osaka (JP); Minoru Miyatake, Osaka (JP); Akinori Nishimura, Osaka (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: NITTO DENKO CORPORATION, Osaka (JP)

(21) Appl. No.: 12/388,739

(22) Filed: Feb. 19, 2009

(30) Foreign Application Priority Data
Feb. 21, 2008 (JP) 2008-040352

(51) Int. Cl. G02B 5/02

(52) U.S. Cl. 359/599

(57) ABSTRACT

A light diffusion film (20) having small back scattering can be obtained by using fibers having two kinds of birefringent regions (21A) and (21B). An outer portion of fiber (21) is a first birefringent region 21A and an inner portion of fiber (21) is a second birefringent region (21B). While the first birefringent region (21A) is in contact with a transparent resin (22), the second birefringent region (21B) is not in contact with the transparent resin (22). When a refractive index (n1) in major axis direction of the first birefringent region (21A) is a value between a refractive index n2 in major axis direction of the second birefringent region (21B) and a refractive index n0 of the transparent resin (22), interface reflection between the transparent resin (22) and the fiber (21) can be reduced, which leads to obtain a light diffusion film (20) having small back scattering.

### BACKGROUND OF THE INVENTION

1. Field of the invention

The present invention relates to a light diffusion film in which a plurality of birefringent fibers arranged on a plane surface parallel to each other are bonded by a transparent resin.

2. Description of Related Art

Light diffusion films are used for various displays for the purpose of making light intensity distribution of light from a light source uniform and avoiding unevenness in brightness of screens. Conventionally, a film in which a plurality of birefringent fibers arranged parallel to each other are embedded in a resin is known as a light diffusion film (JP 2003-302507 A & Polymer Preprints, Japan Vol. 56, No. 2 (2007). However, conventional light diffusion films suffer a significant loss of light due to back scattering (incident light is scattered backward relative to a direction of travel), there has been a problem that the display gets dark. Thus, light diffusion films capable of effectively diffusing light in a forward direction by inhibiting back scattering have been demanded.

Since the conventional light diffusion films have a serious loss of light due to back scattering, it is an object of the present invention to provide a light diffusion film having small back scattering.

### SUMMARY OF THE INVENTION

It has revealed that as a result of studies of inventors of the present invention, a light diffusion film having small back scattering can be obtained by using fibers having two kinds of birefringent regions.

In a first preferred embodiment, a light diffusion film according to the present invention comprises: a plurality of columnar fibers arranged substantially parallel to each other; and a transparent resin for bonding the fibers, wherein the fibers comprise a first birefringent region wherein the fibers extend in a major axis direction, and a second birefringent region composed of a material different from that of the first birefringent region.

In a second preferred embodiment of the light diffusion film according to the present invention, the transparent resin is optically isotropic, the second birefringent region is included inside of the first birefringent region, and a refractive index n0 of the transparent resin, a refractive index n1 in the major axis direction of the first birefringent region, and a refractive index n2 in the major axis direction of the second birefringent region meet the relationship of n0<n1<n2 or n2<n1<n0.

In a third preferred embodiment of the light diffusion film according to the present invention, a plurality of second birefringent regions are included inside of the first birefringent region.

In a fourth preferred embodiment of the light diffusion film according to the present invention, the first birefringent region is composed of olefin-base polymer and the second birefringent regions are composed of vinyl alcohol-base polymer.

In a fifth preferred embodiment of the light diffusion film according to the present invention, the transparent region is an ultraviolet curable resin.

### ADVANTAGES OF THE INVENTION

The present invention provides a light diffusion film having small back scattering.

For a full understanding of the present invention, reference should now be made to the following detailed description of the preferred embodiments of the invention as illustrated in the accompanying drawings.

### BRIEF DESCRIPTION OF THE DRAWINGS

FIG. 1 is a schematic view of a conventional light diffusion film.

FIG. 2 is a schematic view of a light diffusion film of the present invention.

FIG. 3(a) is a schematic view of incident light, transmitted diffusion light, and back scattering light of a conventional light diffusion film. FIG. 3(b) is a schematic view of incident light, transmitted diffusion light, and back scattering light of a light diffusion film of the present invention.

FIGS. 4(a) and (b) are respectively a schematic view of a cross-section of fibers used in the present invention.

FIG. 5 is a graph showing back scattering values according to examples 1 to 3 and a comparative example of the present invention.

### DESCRIPTION OF THE PREFERRED EMBODIMENTS

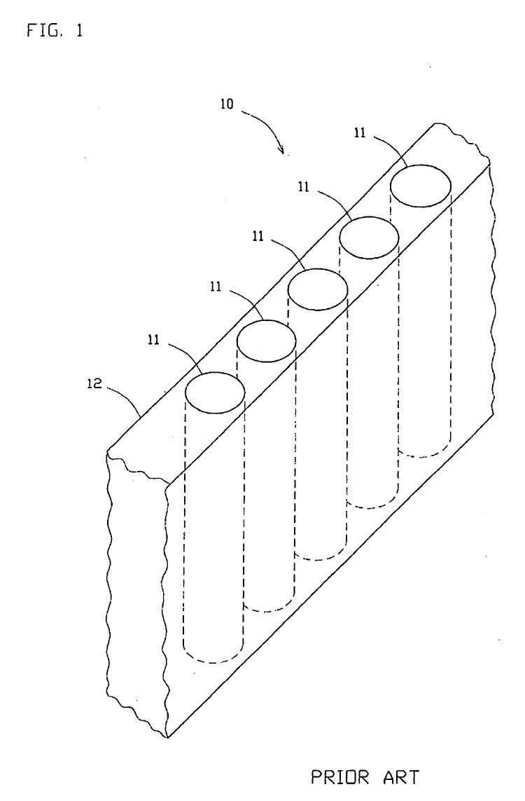

The preferred embodiments of the present invention will now be described with reference to FIGS. 1-5 of the drawings. Identical elements in the various figures are designated with the same reference numerals.

As a result of a careful study conducted by the inventors of the present invention to resolve the above-mentioned problems, it has revealed that a light diffusion film having small back scattering can be obtained by using fibers having two kinds of birefringent regions. In the present invention, the outer portion is a first birefringent region and the inner portion is a second birefringent region. While the first birefringent region is in contact with a transparent resin, the second birefringent region is not in contact with the transparent resin. The refractive index difference at the interface between the transparent resin and the fibers becomes smaller because a refractive index n1 in the major axis direction of the first birefringent region is set between a refractive index n2 in the major axis direction of the second birefringent region and a refractive index n0 of the transparent resin, resulting in fewer interface reflection that occurs at the interface between the transparent resin and the fibers. As a result, a light diffusion film having small back scattering can be obtained.

### (Light Diffusion Film)

The light diffusion film of the present invention comprises: a plurality of columnar fibers arranged substantially parallel to each other on a plane surface; and a transparent resin for bonding the fibers. The fibers comprise: a first birefringent region extending in a major axis direction of the fibers; and a second birefringent region composed of a material different from the first birefringent region and extending in the major axis direction of the fibers. It is preferable that the transparent resin is optically isotropic. The second birefringent region is located in the first birefringent region. The refractive index n1 in the major axis direction of the first birefringent region is a value between the refractive index n2 in the major axis direction of the second birefringent region and the refractive index n0 of the transparent resin. That is n0<n1<n2 or n2<n1<n0.

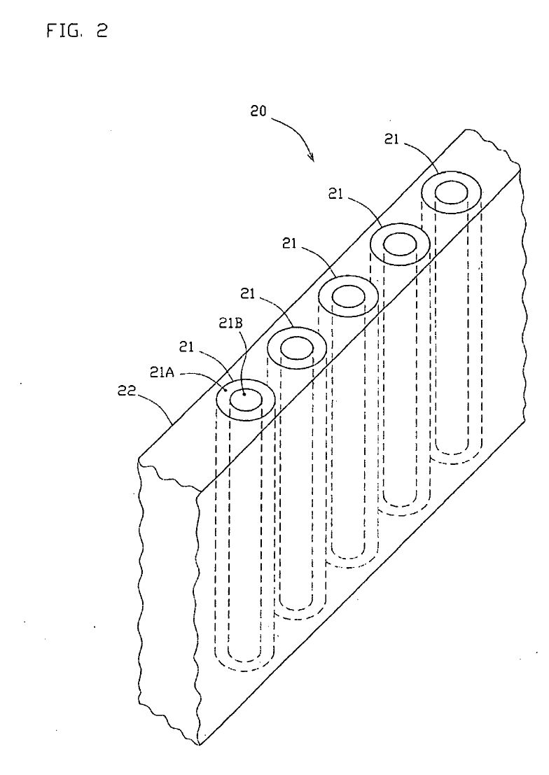

Referring to FIGS. 1 and 2, a conventional light diffusion film and the structure of a light diffusion film of the present invention will now be described. FIG. 1 is a schematic view of an example of a conventional light diffusion film 10. A plurality of columnar birefringent fibers 11 arranged parallel to each other are embedded in an optically isotropic transparent resin 12. The fibers 11 are composed of a single material and have no particular internal structure. FIG. 2 is a schematic view of an example of a light diffusion film 20 of the present invention. A plurality of columnar fibers 21 arranged parallel to each other are embedded in an optically isotropic transparent resin 22. Further, fibers 21 respectively have an internal structure which comprises: a first birefringent region 21A extending in the major axis direction of a fiber 21; and a second birefringent region 21B extending in the major axis direction composed of a material different from the first birefringent region 21A. The second birefringent region 21B is located in the first birefringent region 21A. The refractive index n1 in the major axis direction of the first birefringent region 21A is set between the refractive index n2 in the major axis direction of the second birefringent region 21B and the refractive index n0 of the transparent resin 22. That is, such three refractive indices are: n0<n1<n2 or n2<n1<n0. The first birefringent region 21A and the second birefringent region 21B are generally different due to different material.

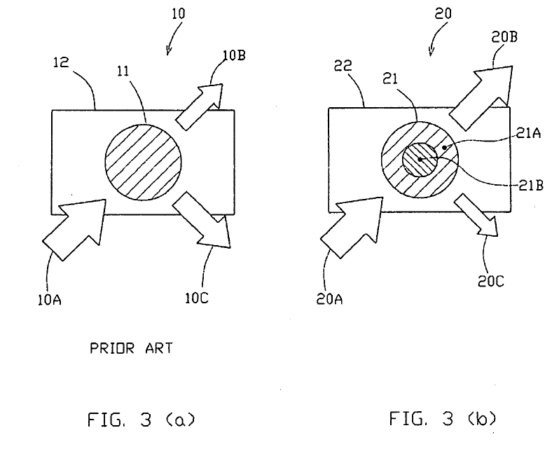

Referring to FIGS. 3(a) and 3(b), functions of the conventional light diffusion film 10 and the light diffusion film 20 of the present invention are illustrated. FIG. 3(a) is a schematic view of incident light 10A in the conventional light diffusion film 10, transmitted diffusion light 10B, and back scattering light 10C. In the conventional light diffusion film 10, the amount of the back scattering light 10C generated by interface reflection between the transparent resin 12 and the fiber 11 becomes larger and the amount of the transmitted diffusion light 10B becomes smaller because of the large refractive index difference between the transparent resin 12 and the fiber 11. FIG. 3(b) is a schematic view of incident light 20A in the light diffusion film 20 of the present invention, transmitted diffusion light 20B, and back scattering light 20C. In the light diffusion film 20 of the present invention, the amount of the back scattering light 20C generated by interface reflection between the transparent resin 22 and the first birefringent region 21A becomes smaller and the amount of the transmitted diffusion light 20B becomes larger because of the small refractive index difference between the transparent resin 22 and the first birefringent region 21A. As a result, a light diffusion film having small back scattering can be obtained.

The thickness of the light diffusion film of the present invention is preferably 5 μm to 200 μm.

The light diffusion film of the present invention exhibits diffusion characteristics in a unitary direction in which diffusion characteristics in the minor axis direction of the fibers are preferably larger than those in the major axis direction of the fibers. Diffusion characteristics in a unitary direction are obtained because of columnar fibers. And arranging a plurality of fibers substantially parallel to each other further strengthens its characteristics. The term “substantially parallel” used herein means that the inclination against a truly parallel reference direction is three-dimensionally within ±20 degrees, more preferably within ±10 degrees. Even if the fibers 21 are not exactly arranged parallel to each other, the effects of the present invention can be obtained sufficiently if only the fibers are substantially in a state of parallel.

### (Fibers)

The columnar fibers used in the present invention comprise: a first birefringent region extending in the major axis direction of the fibers; and a second birefringent region composed of a material different from the first birefringent region and extending in the major axis direction of the fibers. Generally, the refractive index of the first birefringent region differs from the refractive index of the second birefringent region because of different material. Since the second birefringent region is included inside of the first birefringent region, the first birefringent is in contact with the transparent resin. The aforementioned fibers preferably have translucency and are more preferably colorless and translucent. When the fibers are in a columnar shape, the diameter is preferably 2 μm to 50 μm, more preferably 2 μm to 30 μm. The fibers may be in the shape of a polygonal column, such as a triangle column and a quadratic column or a shape in which those angles are smooth. In this case, the maximum dimension of a cross section perpendicular to the major axis direction is preferably 2 μm to 50 μm, more preferably 2 μm to 30 μm.

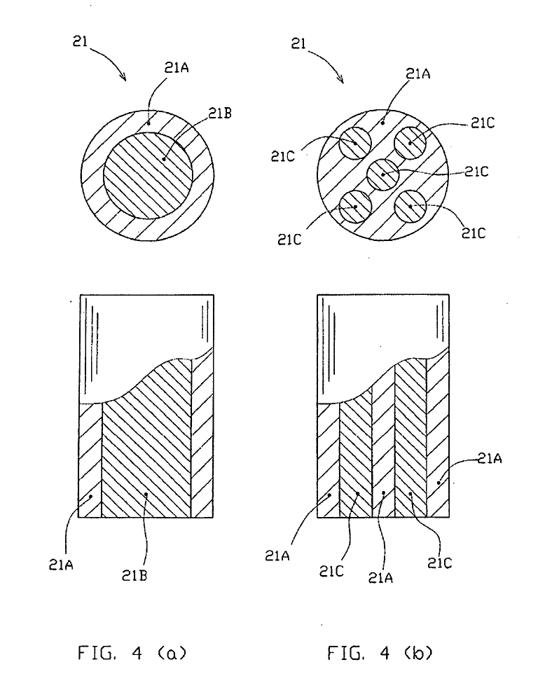

Any fibers may be used in the present invention, if only the fibers comprise two kind of birefringent regions extending in the major axis direction wherein the second birefringent region is located in the first birefringent region. For instance, FIG. 4(a) shows a core-in-sheath structure wherein the single second birefringent region 21B is located in the first birefringent region 21A. FIG. 4(b) shows a sea-island structure or the like wherein a plurality of second birefringent regions 21C are located in the first birefringent region 21A. In the case of the sea-island structure, the cross section of an island portion (the second birefringent region 21C) is preferably 0.1 μm to 10 μm, more preferably 0.7 μm to 5 μm. Wavelength dependence of diffusion light strength could arise in a visible light region (wavelength 380 nm to 780 nm) when the cross section of the island portion is too small, which may color the light diffusion film.

While FIGS. 4(a) and 4(b) respectively show that a fiber 21 consists of the first birefringent region 21A and the second birefringent regions 21B and 21C, the fiber used in the present invention may comprise a third birefringent region not shown in the figures or an optical isotropic region. In FIG. 4(b), the second birefringent regions 21C are in the shape of a column, however, the second birefringent regions 21C may be any polygonal column-shaped, such as triangle column-shaped, quadratic column-shaped, and column-shaped having smooth angles or the like. In the case of the cylindrical shape, the size of the cross section is its diameter and in the case of the polygonal column shape, the size of the cross section is the maximum crossing dimensions. Further, the second birefringent regions 21C do not need to be uniformly located in the first birefringent region 21A but may be eccentrically-located.

The fibers used in the present invention are preferably sea-island structures shown in FIG. 4(b). Compared with the core-in-sheath structure, in a sea-island structure, the cross section area of the second birefringent region becomes smaller and in addition to that, diffusion points of light are increased, which enables to obtain a light diffusion film which can emit incident light while diffusing the incident light in a wider range ahead.

In the light diffusion film of the present invention, it is preferable that a refractive index n0 of the transparent resin, a refractive index n1 in the major axis direction of the first birefringent region, and a refractive index n2 in the major axis direction of the second birefringent region satisfy the relationship of n0<n1<n2 or n2<n1<n0, that is, the refractive index n1 in the major axis direction of the first birefringent region is set between the refractive index n2 in the major axis direction of the second birefringent region and the refractive index n0 of the transparent resin 22. As has been described above, in the light diffusion film wherein the refractive index gradates, a refractive index difference becomes smaller at an interface of each member, so that interface reflection occurs at the interface between the transparent resin and the fibers, resulting in smaller back scattering.

In the light diffusion film of the present invention, a refractive index difference |n2−n0| between the second birefringent region and the transparent resin is a major factor to determine a diffusion range of transmitted diffusion light in a surface perpendicular to the major axis of the fibers. The refractive index difference |n2−n0| is preferably 0.02 or more and more preferably 0.04 or more to widen the diffusion range of the transmitted diffusion light. In view of the balance between back scattering light and transmitted diffusion light, the refractive index difference |n2−n0| is preferably 0.20 or less and more preferably 0.15 or less.

In the light diffusion film of the present invention, the relationship between the refractive index n0 of the transparent resin and the refractive index n2′ in the minor axis direction of the second birefringent region is preferably |n2′−n0|<0.06. The light diffusion film that satisfies the relationship may be used as a scattered polarizer to scatter one polarizing component so that another polarizing component may be permeated when dividing incident light into two polarizing components that are mutually perpendicular.

### (Birefringent Region)

The term “Birefringent region” used herein means a region wherein the difference (birefringent index Δn=n−n′) between a refractive index n in a major axis direction of the fibers and a refractive index n′ in a minor axis direction of the fibers is 0.001 or more.

The first birefringent region and the second birefringent region composed of fibers used in the present invention are formed by any material excellent in transparency and exhibiting birefringence. The fibers used in the present invention preferably comprise at least two kinds of polymer materials. Examples of the materials forming the first and second birefringent regions include olefin-base polymer, vinyl alcohol-base polymer, (metha)acryl-base polymer, ester-base polymer, stylene-base polymer, imido-base polymer, amide-base polymer, liquid crystal polymer or the like and blended polymer of these polymers. A preferable combination of materials for forming the first birefringent region and the second birefringent region is that the first birefringent region is olefin-base polymer and the second birefringent region is vinyl alcohol-base polymer. Such combination makes it possible to obtain large birefringence because of excellent stretching properties. Further, excellent adhesion of the first birefringent region and the second birefringent region makes it possible to prevent a clearance (air layer) at the interface of each region, which leads to obtain excellent diffusion characteristics.

Examples of the above-mentioned olefin-base polymer include polyethylene, polypropylene, ethylene propylene copolymer and their blended polymer or the like. Examples of the above-mentioned vinyl alcohol-base polymer include polyvinyl alcohol, ethylene vinyl alcohol copolymer and their blended polymer or the like.

A birefringent index Δn1 of the first birefringent region (the difference between the refractive index n1 in the major axis direction and the refractive index n1′ in the minor axis direction: n1−n1′) is preferably 0.001 to 0.20, more preferably 0.001 to 0.10. A birefringent index Δn2 of the second birefringent region (the difference between the refractive index n2 in the major axis direction and the refractive index n2′ in the minor axis direction: n2−n2′) is preferably 0.01 to 0.30, more preferably 0.02 to 0.20. The light diffusion film wherein each birefringent region shows the above-mentioned birefringent value exhibits good diffusion properties.

The difference |n1−n2| between the refractive index n1 in the major axis direction of the first birefringent region and the refractive index n2 in the major axis direction of the second birefringent region in the fibers used in the present invention is adjusted as appropriate in accordance with the refractive index n0 of the transparent resin and is preferably 0.01 or more, more preferably 0.02 to 0.15.

It is possible to increase or decrease the above-mentioned birefringent indices and the refractive index difference by selecting the kinds of materials and manufacturing conditions (for instance, stretching magnification) as appropriate.

### (Transparent Resin)

The term “transparent resin” used herein means a transparent resin having a transmittance of 80% or higher in a wavelength of 546 nm. The transparent resin used in the present invention preferably combines the fibers and is formed by any materials excellent in transparency. Examples of the material of the transparent resin used in the present invention include an ultraviolet curable resin, cellulose-base polymer, norbornene-base polymer or the like. An energy curable resin is preferable as a transparent resin, more specifically, an ultraviolet curable resin is preferable. The ultraviolet curable resin has high productivity because the ultraviolet curable resin can form films at a high speed.

The refractive index n0 of the transparent resin is preferably 1.3 to 1.7, more preferably 1.4 to 1.6. It is possible to increase or decrease the refractive index n0 of the transparent resin as appropriate by changing the kinds of organic groups to be introduced into resin and/or the content. For instance, it is possible to increase the refractive index of the transparent resin by introducing a cyclic aromatic group (phenyl group or the like) into the transparent resin. On the other hand, it is possible to decrease the refractive index of the transparent resin by introducing an aliphatic system group (methyl group or the like) into the transparent resin.

The transparent resin used in the present invention is preferably an optically isotropic resin with small refractive index anisotropy. The term “optically isotropic” used herein means that the birefringent index (the difference between the refractive index in the maximum direction and the refractive index in the minimum direction) is less than 0.001.

While fibers are fully embedded in the transparent resin, fibers may be combined each other or the fibers may be insufficiently embedded in the transparent resin where fibers may be partially exposed. The amount of the transparent resin used is preferably 10 weight parts to 500 weight parts with reference to 100 weigh parts of fibers.

### (Manufacturing Method)

The light diffusion film of the present invention can be obtained by respectively arranging a plurality of fibers on a plane surface parallel to each other and applying a solvent for respectively forming a transparent resin on the surface of the fiber to solidify or harden the applied layers so that the fibers can be fixed.

For instance, the fibers having the first and second birefringent regions can be prepared by stretching a spinning filament including two different kinds of materials. Such a spinning filament can be prepared by respectively melting at least two kinds of polymer materials to be expelled from a spinning nozzle. Alternatively, the spinning filament can be prepared by coating other material on a surface of a unitary structured spinning filament.

While methods for arranging a plurality of fibers parallel to each other are not particularly limited, for instance, an ordinary manufacturing method for non-woven fabric may be applied. Specifically, examples of the methods include a dry method for making short fibers to be in the form of a sheet with a spinning guard, a spunbonding method for accumulating long fibers obtained from a spinning nozzle, and a wet method for making extremely short fibers in the form of a sheet by dispersing the extremely short fibers into water after passing a papermaking process or the like.

Example of methods for fixing a plurality of fibers include a method for solidifying a resin by applying the resin dissolved in a solvent onto the surfaces of a plurality of fibers to be dried under the conditions of the solvent vaporizes and a method for curing the resin by applying an ultraviolet curable resin on the surfaces of a plurality of fibers to irradiate ultraviolet rays.

### (Usage of Light Diffusion Film)

Light diffusion films of the present invention are for example, preferably used for liquid crystal panels for computers, copy machines, cell phones, watches, digital cameras, Personal Digital Assistance, portable game devices, video cameras, televisions, electronics ovens, car navigation systems, car audio videos, store monitors, supervisory monitors, and monitors for medical purposes or the like.

### EXAMPLES

### Example 1

An ethylene propylene copolymer of excessive propylene (produced by Japan Polypropylene Corporation, Product Name “OX1066A”, melting point: 138° C.) and an ethylene vinyl alcohol copolymer (produced by Nippon Synthetic Chemical Industry Co., Ltd. Product Name: “Soarnol DC321B,” melting point: 181° C.) were respectively fused at 230° C. and 270° C. and then were charged into a nozzle for sea-island composite fiber spinning (island number per fiber cross section: 37) to obtain a spinning filament with a diameter of 30 μm by spinning these copolymers at a pulling rate of 600 m/minute.

This spinning filament was stretched 4 times as long as the original length in warm water at 60° C. to obtain fibers with a diameter of 15 μm. When the cross section surfaces of the fibers were observed with an electron microscope, it was confirmed that a sea-island structure was configured wherein a columnar (diameter of its cross section: approximately 1 μm) second birefringent region (island portion) composed of an ethylene vinyl alcohol copolymer was distributed inside a columnar (diameter of its cross section: 15 μm) first birefringent region (sea portion) composed of an ethylene propylene copolymer.

A number of the above-mentioned fibers were prepared. And then the fibers were arranged so that a major direction of the fibers might be parallel to one another on a surface of a polyethylene terephthalate film (thickness: 38 μm) on which a polyethylene acrylate-base ultraviolet curable resin (produced by Sartomer Company Inc., Product Name: “CN2302”) was applied as an optically isotropic transparent resin so that the fibers might be embedded therein. Subsequently, the transparent resin was cured by irradiating ultraviolet rays (illuminance=40 mW/cm², amount of integrating light: 1,000 mJ/cm²) and then the polyethylene terephthalate film was peeled off to prepare a light diffusion film with a thickness of 150 μm. The used amount of the ultraviolet curable resin was 100 weight parts with respect to 100 weight parts of the fibers.

In the light diffusion film prepared in such a manner, when parallel (collimated) light entered, large diffusion light was emitted in a minor axis direction of the fibers, so that the light diffusion film had unitary directional diffusion characteristics that diffusion light was hardly emitted in the major axis direction of the fibers. Refractive indices of the fibers and the transparent resin, and back scattering values in the light diffusion film were as shown in Table 1. These back scattering values were indicated as relative values when back scattering values in Comparative Example was 100

### Example 2

A light diffusion film with a thickness of 150 μm was prepared in the same manner as in Example 1 except for using a polyester acrylate-base ultraviolet curable resin (produced by Sartomer Company, Inc., Product Name: “CN2273”) as an optically isotropic transparent resin. The refractive indices of the fibers and the transparent resin, and the back scattering values in the light diffusion film were as shown in Table 1.

### Example 3

A light diffusion film with a thickness of 150 μm was prepared in the same manner as in Example 1 except for using a polyester acrylate-base ultraviolet curable resin (produced by Sartomer Company, Inc., Product Name: “CN2270”) as an optically isotropic transparent resin. The refractive indices of the fibers and the transparent resin, and the back scattering values in the light diffusion film were as shown in Table 1.

### Comparative Example

An ethylene vinyl alcohol copolymer (produced by Nippon Synthetic Chemical Industry Co., Ltd., Product Name “Soarnol DC321B,” melting point: 181° C.) was fused at 270° C. and then was charged into a nozzle for unitary-structure fabric spinning to obtain a spinning filament with a diameter of 30 μm by spinning the copolymer at a pulling rate of 600 m/minute. This spinning filament was stretched 4 times as long as the original length in warm water at 60° C. to obtain fibers with a diameter of 15 μm.

A light diffusion film with a thickness of 150 μm was prepared in the same manner as in Example 1 except for using a polyester acrylate-base ultraviolet curable resin (produced by Sartomer Company, Inc., Product Name: “CN2270”) as an optically isotropic transparent resin. The refractive indices of the fibers and the transparent resin, and the back scattering values in the light diffusion film were as shown in Table 1.

TABLE 1

| | | | | | | Refractive | |
|---|---|---|---|---|---|---|---|
| | | | | | | index | |
| | Fiber | | | | | difference | |
| | First birefringent | | Second birefringent | | | in | Back |
| | region | | region | | | interface | scattering |
| | Refractive | Refractive | Refractive | Refractive | Refractive | between | value of |
| | index n1 in | index n1′ in | index n2 in | index n2′ in | index n0 of | transparent | light |
| | major axis | minor axis | major axis | minor axis | transparent | resin | diffusion |
| | direction | direction | direction | direction | resin | and fiber | film |
| Example 1 | 1.51 | 1.49 | 1.57 | 1.52 | 1.50 | 0.01 | 36 |
| Example 2 | 1.51 | 1.49 | 1.57 | 1.52 | 1.48 | 0.03 | 42 |
| Example 3 | 1.51 | 1.49 | 1.57 | 1.52 | 1.47 | 0.04 | 51 |
| Comparative | Nil | Nil | 1.57 | 1.52 | 1.47 | 0.10 | 100 |
| Example | | | | | | | |

### (Assessment)

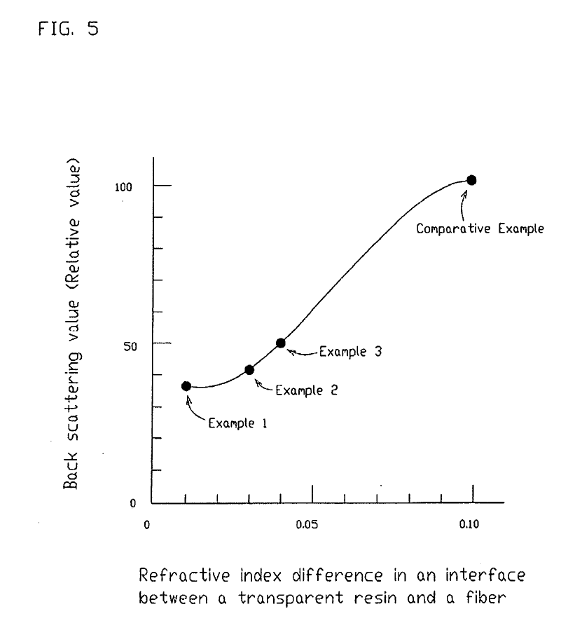

FIG. 5 is a graph showing back scattering values in Examples 1 to 3 and Comparative Example. The horizontal axis shows refractive index differences at the interface between a transparent resin and fibers and the vertical axis shows relative back scattering values when the back scattering values in the Comparative Example is 100. As you can see from the graph, the larger the refractive index differences at the interface between the transparent resin and the fibers become, the larger the back scattering values become. Reflection at the interface easily occurs when the refractive index differences between the fibers and the transparent resin are large like the Comparative Example, resulting in larger back scattering. In Examples 1 to 3, fibers are indicated as sea-island structures and the refractive indices are gradually reduced in the order of islands (second birefringent region)→sea (first birefringent region)→the transparent resin, so that reflection at the interface is controlled, resulting in smaller back scattering.

### (Measurement Method)

### (Back Scattering)

A black acrylic board was adhered to the back of a light diffusion film and then an inclined reflectivity at an angle of 5 degrees was measured with a spectrophotometer produced by Hitachi Ltd., Product Name: “U-4100.” The measured value was detected in the sum of the back scattering value and the surface reflectivity because forward diffusion light is absorbed into the black acrylic board in the measurement method. Back scattering values in the Examples 1 to 3 and the Comparative Example were obtained by subtracting the previously measured surface reflectivity of the transparent resin from the above-mentioned measured values.

### (Refractive Index of Fibers)

A refractive index at room temperature (25° C.) and at the wavelengths of 546 nm was measured by the Becke's line method using a polarization microscope produced by Olympus Corporation.

### (Refractive Index of Transparent Resin)

A refractive index at room temperature (25° C.) and at the wavelengths of 546 nm was measured using a prism coupler produced by Sairon Technology Ltd.

It is to be understood that the present invention may be practiced in other embodiments in which various improvements, modifications, and variations are added on the basis of knowledge of those skilled in the art without departing from the spirit of the present invention. Further, any of the specific inventive aspects of the present invention may be replaced with other technical equivalents for embodiment of the present invention, as long as the effects and advantages intended by the invention can be insured. Alternatively, the integrally configured inventive aspects of the present invention may comprise a plurality of members and the inventive aspects that comprise a plurality of members may be practiced in a integrally configured manner.

There has thus been shown and described a novel light diffusion film which fulfills all the objects and advantages sought therefor. Many changes, modifications, variations and other uses and applications of the subject invention will, however, become apparent to those skilled in the art after considering this specification and the accompanying drawings which disclose the preferred embodiments thereof. All such changes, modifications, variations and other uses and applications which do not depart from the spirit and scope of the invention are deemed to be covered by the invention, which is to be limited only by the claims which follow.

This application claims priority from Japanese Patent Application No. 2008-040352, which is incorporated herein by reference.

What is claimed is:

1. A light diffusion film comprising:
a plurality of columnar fibers arranged substantially parallel to each other; and
a transparent resin for bonding the fibers, wherein the fibers comprise a first birefringent region in which the fibers extend in a major axis direction and a second birefringent region composed of a material different from the first birefringent region.

2. The film according to claim 1, wherein the transparent resin is optically isotropic, the second birefringent region is included inside of the first birefringent region, and a refractive index n0 of the transparent resin, a refractive index n1 in a major axis direction of the first birefringent region, and a refractive index n2 in a major axis direction of the second birefringent region meet the relationship of n0<n1<n2 or n2<n1<n0.

3. The film according to claim 2, wherein a plurality of second birefringent regions are included inside of the first birefringent region.

4. The film according to claim 2 or 3, wherein the first birefringent region is composed of olefin-base polymer and the second birefringent region is composed of vinyl alcohol-base polymer.

5. The film according to any one of claims 1 to 3, wherein the transparent resin is an ultraviolet curable resin.

6. The film according to claim 4, wherein the transparent resin is an ultraviolet curable resin.
